(19) United States
(12) Patent Application Publication
(10) Pub. No.: US 2021/0045402 A1
(43) Pub. Date: Feb. 18, 2021

(54) METHOD FOR SUPPRESSING INCREASE IN ANISIDINE VALUE AND DECREASE IN AMOUNT OF TOCOPHEROLS IN FRYING FATS AND OILS COMPOSITION

(71) Applicant: J -OIL MILLS, INC., Tokyo (JP)

(72) Inventors: Masayoshi SAKAINO, Tokyo (JP); Naruto MAKITA, Tokyo (JP); Ryuji HORI, Tokyo (JP); Hisashi ARAI, Tokyo (JP); Ryo OKABE, Tokyo (JP); Takashi SANO, Tokyo (JP)

(21) Appl. No.: 16/965,522

(22) PCT Filed: Jan. 21, 2019
(86) PCT No.: PCT/JP2019/001618

§ 371 Date: Jul. 28, 2020

(30) Foreign Application Priority Data
Jan. 31, 2018 (JP) 2018-015953

(51) Int. Cl. A23D 9/06; C11B 3/12; C11B 3/14; A23D 9/04

(52) U.S. Cl. CPC A23D 9/06; A23D 9/04; C11B 3/14; C11B 3/12

(57) ABSTRACT

[Problem] To provide: a method for suppressing an increase in the anisidine value and a decrease in the amount of tocopherols in a fats and oils composition during frying; an inhibitor for suppressing an increase in the anisidine value; and an inhibitor for suppressing a decrease in the amount of tocopherols.

[Solution] The present invention provides a method for suppressing an increase in the anisidine value and a method for suppressing a decrease in the amount of tocopherols, the method comprising a step for adding a prepared oil to edible fats and oils, wherein the prepared oil is obtained through (1) a degumming step, (2) a neutralization step which may or may not be performed, (3) a bleaching step which may or may not be performed, and (4) a deodorizing step, which may or may not be performed, in this order, in the process of refining a crude oil obtained from an oil feedstock, and the absorbance difference, between the absorbance at a wavelength of 660 nm and the absorbance at a wavelength of 750 nm, of the prepared oil obtained from step (3) is at least 0.030 when isooctane is used as the control. The inhibitor for suppressing an increase in the anisidine value, and the inhibitor for suppressing a decrease in the amount of tocopherols are characterized by containing said prepared oil.

### TECHNICAL FIELD

The present invention relates to a method for suppressing increase in an anisidine value and decrease in an amount of tocopherols in a frying fats and oils composition, more specifically the suppressing method characteristically using a prepared oil obtained by adjusting a process of refining a crude oil.

### BACKGROUND ART

As oils for cooking fried foods such as fry and tempura, edible oils or fats such as soybean oil and rapeseed oil are used. Although these edible oils and fats are inexpensive and easy to treat (handle), they cause coloration, raised viscosity, cooked odor, or the like during cooking with heat.

As a prior art for suppressing heat coloration in frying a foodstuff with an edible oil or fat, Patent Document 1 proposes a method for improving heat resistance of a frying fats and oils composition by adding a pressed oil and/or extracted oil, and a phosphorus-derived component such as degummed oil to a refined edible oil or fat. According to the invention in Patent Document 1, it is possible to improve heat stability of the frying fats and oils composition, particularly to suppress heat coloration and cooked odor.

An anisidine value is a numerical value indicating a content of an aldehyde that is produced as oxidation of an oil or fat progresses, and is one of indicators for deterioration of the oil or fat. Suppression of increase in the anisidine value of the oil or fat during frying is considered to be effective for suppressing deterioration of a frying fats and oils composition.

Tocopherols naturally contained in an oil feedstock remain in a refined oil or fat. The tocopherols in the refined oil or fat disappear by heating or the like. Since tocopherols have an antioxidative action on edible oils or fats, suppression of decrease in an amount of tocopherols in an edible oil or fat during frying is considered to be effective for suppressing deterioration of the frying fats and oils composition.

### PRIOR ART DOCUMENTS

### Patent Documents

Patent Document 1: Japanese Patent Application Laid-Open No. 2009-050234 (Method for Producing an Oil and Fat Composition for Deep-Fried Food Having Excellent Heat Resistance)

### SUMMARY OF INVENTION

### Problem to be Solved

The invention in Patent Document 1 is not intended to suppress increase in the anisidine value and decrease in the amount of tocopherols. Thus, an object of the present invention is to provide a method for suppressing increase in the anisidine value and/or decrease in the amount of tocopherols in the frying fats and oils composition.

### Solution to Problem

As a result of intensive studies on the above problems, the inventors have found that adding a prepared oil obtained by adjusting a refining process so as to meet a certain condition to an edible oil or fat is effective for suppressing increase in an anisidine value and decrease in an amount of tocopherols in an oil or fat composition during frying, and this finding has led to completion of the present invention. That means, the present invention relates to a method for suppressing increase in an anisidine value of a frying fats and oils composition, the method including adding a prepared oil to an edible oil or fat, wherein

the prepared oil is obtained through

(1) a degumming step,

(2) a neutralization step which is performed or not performed,

(3) a bleaching step which is performed or not performed, and

(4) a deodorizing step which is performed or not performed, in this order, in a process of refining a crude oil obtained from an oil feedstock, and

an absorbance difference determined by subtracting an absorbance at a wavelength of 750 nm from an absorbance at a wavelength of 660 nm of the prepared oil after the step (3) is at least 0.030 when isooctane is used as a control.

Although Patent Document 1 describes an intermediate oil or fat such as a degummed oil, and a crude refined oil obtained by process excluding only a neutralization step, Patent Document 1 discloses no prepared oil having such an absorbance difference as prescribed in the present invention.

Preferably, the absorbance difference is at least 0.045.

Preferably, the deodorizing step (4) is performed.

Preferably, the deodorizing step is performed under a condition that a usage amount of water vapor is 0.1% by mass or more and 10% by mass or less, a deodorizing temperature is 210° C. or more and 300° C. or less, and a deodorizing time is 10 minutes or more and 240 minutes or less.

Preferably, the oil feedstock is at least one selected particularly from soybean, rapeseed, and palm flesh.

Preferably, the edible oil or fat contains at least one selected particularly from soybean oil, rapeseed oil, palm-based oil or fat, corn oil, sunflower oil, olive oil, cottonseed oil, rice bran oil, and safflower oil.

Preferably, a content of the prepared oil in the frying fats and oils composition is 0.05% by mass or more and 20% by mass or less.

In the method for suppressing increase in the anisidine value, the prepared oil may be added to the edible oil or fat such that a phosphorus content derived from the prepared oil in the frying fats and oils composition is 0.01 ppm by mass or more and 10 ppm by mass or less.

Preferably, the bleaching step (3) is performed.

Also, the present invention relates to a method for suppressing decrease in an amount of tocopherols in a frying fats and oils composition, the method including adding a prepared oil to an edible oil or fat, wherein

the prepared oil is obtained through

(1) a degumming step,

(2) a neutralization step which is performed or not performed,

(3) a bleaching step which is performed or not performed, and

(4) a deodorizing step which is performed or not performed, in this order, in a process of refining a crude oil obtained from an oil feedstock, and

an absorbance difference determined by subtracting an absorbance at a wavelength of 750 nm from an absorbance at a wavelength of 660 nm of the prepared oil after the step (3) is at least 0.030 when isooctane is used as a control. In this specification, tocopherols refer to α, β, γ and δ-tocopherol, as well as α, β, γ and δ-tocotrienol.

Preferably, the absorbance difference is at least 0.045.

Preferably, the deodorizing step (4) is performed.

Preferably, the deodorizing step is performed under a condition that a usage amount of water vapor is 0.1% by mass or more and 10% by mass or less, a deodorizing temperature is 210° C. or more and 300° C. or less, and a deodorizing time is 10 minutes or more and 240 minutes or less.

Preferably, the oil feedstock is at least one selected particularly from soybean, rapeseed, and palm flesh.

Preferably, the edible oil or fat contains at least one selected particularly from soybean oil, rapeseed oil, palm-based oil or fat, corn oil, sunflower oil, olive oil, cottonseed oil, rice bran oil, and safflower oil.

Preferably, a content of the prepared oil in the frying fats and oils composition is 0.05% by mass or more and 20% by mass or less.

In the method for suppressing decrease in the amount of tocopherols, the prepared oil may be added to the edible oil or fat such that a phosphorus content derived from the prepared oil in the frying fats and oils composition is 0.01 ppm by mass or more and 10 ppm by mass or less.

Also, the present invention relates to an inhibitor for suppressing increase in an anisidine value of a frying fats and oils composition, the inhibitor for suppressing increase in the anisidine value containing a prepared oil, wherein

the prepared oil is obtained through

(1) a degumming step,

(2) a neutralization step which is performed or not performed,

(3) a bleaching step which is performed or not performed, and

(4) a deodorizing step which is performed or not performed, in this order, in a process of refining a crude oil obtained from an oil feedstock, and

an absorbance difference determined by subtracting an absorbance at a wavelength of 750 nm from an absorbance at a wavelength of 660 nm of the prepared oil after the step (3) is at least 0.030 when isooctane is used as a control.

Also, the present invention relates to an inhibitor for suppressing decrease in an amount of tocopherols in a frying fats and oils composition, the inhibitor for suppressing decrease in the amount of tocopherols containing a prepared oil, wherein

the prepared oil is obtained through

(1) a degumming step,

(2) a neutralization step which is performed or not performed,

(3) a bleaching step which is performed or not performed, and

(4) a deodorizing step which is performed or not performed, in this order, in a process of refining a crude oil obtained from an oil feedstock, and

an absorbance difference determined by subtracting an absorbance at a wavelength of 750 nm from an absorbance at a wavelength of 660 nm of the prepared oil after the step (3) is at least 0.030 when isooctane is used as a control.

### Effects of Invention

The method for suppressing increase in the anisidine value of the frying fats and oils composition and an inhibitor for suppressing increase in the anisidine value of the frying fats and oils composition according to the present invention make it possible to significantly suppress increase in the anisidine value of the fats and oils composition compared to increase in the anisidine value of a control oil with no prepared oil even if the frying fats and oils composition is used for frying a foodstuff e.g. for as long as 30 hours. This suppression of increase in the anisidine value greatly contributes to life prolongation of the frying fats and oils composition.

Also, the method for suppressing decrease in the amount of tocopherols in the frying fats and oils composition and an inhibitor for suppressing decrease in the amount of tocopherols in the frying fats and oils composition according to the present invention make it possible to significantly suppress decrease in the amount of tocopherols in the fats and oils composition compared to decrease in the amount of tocopherols in a control oil with no prepared oil even if the frying fats and oils composition is used for frying a foodstuff e.g. for as long as 30 hours. This suppression of decrease in the amount of tocopherols greatly contributes to life prolongation of the frying fats and oils composition.

### DESCRIPTION OF EMBODIMENTS

Hereinafter, embodiments of the present invention will be explained. The method for suppressing increase in the anisidine value of the frying fats and oils composition during heating according to the present invention (hereinafter, referred to as the Present Invention 1) includes a step of adding a prepared oil to an edible oil or fat. The edible oil or fat serves as a base oil for the frying fats and oils composition. The edible oil or fat is usually a refined oil. Examples of the edible oil or fat include: a vegetable oil or fat such as soybean oil, rapeseed oil, palm oil, palm kernel oil, corn oil, sunflower oil, olive oil, cottonseed oil, safflower oil, linseed oil, sesame oil, rice bran oil, peanut oil, and coconut oil; an animal oil or fat such as lard, beef tallow, chicken fat, and milk fat; medium chain fatty acid triglyceride; and a processed oil or fat thereof obtained by fractionation, hydrogenation, transesterification, or the like. Each of these edible oils or fats may be used alone or in combination. The edible oil or fat is preferably at least one selected from soybean oil, rapeseed oil, palm-based oil or fat, corn oil, sunflower oil, olive oil, grape seed oil, cottonseed oil, rice bran oil, and safflower oil, more preferably contains at least one selected from soybean oil, rapeseed oil, and palm-based oil or fat. In the edible oil or fat, the total content of the soybean oil, rapeseed oil, palm-based oil or fat, corn oil, sunflower oil, olive oil, cottonseed oil, rice bran oil, and safflower oil is preferably 60% by mass or more and 100% by mass or less, more preferably 75% by mass or more and 100% by mass or less, even more preferably 90% by mass or more and 100% by mass or less, particularly preferably 100% by mass. Herein, the palm-based oil or fat refers to a palm oil and a processed palm oil or fat.

The edible oil or fat has a melting point of preferably 10° C. or less, more preferably 0° C. or less. Note that, in this specification, the melting point refers to a slip melting point. The slip melting point can be measured in accordance with Standard Methods for the Analysis of Fats, Oils and Related Materials 2. 2. 4. 2-1996.

A content of the edible oil or fat is usually 80% by mass or more, preferably 85% by mass or more, particularly preferably 88% by mass or more based on the frying fats and oils composition. Although the upper limit of the content of the edible oil or fat is not particularly set, the total content of the edible oil or fat and the prepared oil is 100% by mass or less.

The prepared oil is obtained through (1) a degumming step, (2) a neutralization step which is performed or not performed, (3) a bleaching step which is performed or not performed, and (4) a deodorizing step which is performed or not performed, in this order, in a process of refining a crude oil obtained from an oil feedstock.

Examples of the oil feedstock include soybean, rapeseed, palm flesh, corn, olive, grape seed, sesame, safflower, sunflower, cottonseed, rice bran, peanut, palm kernel, coconut, linseed, and the like. The oil feedstock is preferably at least one selected from soybean, rapeseed, and palm flesh, more preferably at least one selected from soybean and rapeseed.

The crude oil can be obtained by squeezing extraction and/or solvent extraction of the oil feedstock. In the squeezing extraction, an oil content in a cell is squeezed out by applying a high pressure to the oil feedstock. The squeezing extraction is suitable for an oil feedstock having a relatively high oil content, like sesame. In the solvent extraction, the oil feedstock is pressed or squeezingly extracted, then a residue is brought into contact with a solvent, an oil content is extracted as a solvent solution, and from the obtained solution, the solvent is distilled off to obtain an oil content. The solvent extraction is suitable for an oil feedstock having a low oil content, like soybean. For the solvent, an organic solvent such as hexane is used.

In the degumming step (1), a gummy matter contained in the oil content and including a phospholipid as a main ingredient is removed by hydration. In the present invention, processing conditions for the degumming step are not particularly limited, and general-purpose conditions can be used. For example, a usage amount of water is usually 1% by mass or more and 5% by mass or less, preferably 1.5% by mass or more and 3% by mass or less based on the crude oil. A degummer aid composed of an aqueous solution of an acid such as oxalic acid, citric acid, and phosphoric acid may be appropriately added. A degumming temperature is usually 40° C. or more and 95° C. or less, preferably 60° C. or more and 95° C. or less. Water vapor or water is added to the crude oil and stirred, so that the gummy matter is hydrated to become water-soluble, and moves to a water layer. A stirring time is usually 1 minute or more and 60 minutes or less. This water layer is separated and removed by a centrifuge to obtain a degummed oil.

In the neutralization step (2), the oil is processed with an aqueous solution of an alkali such as sodium carbonate and caustic soda to remove a free fatty acid as a soap content in the oil content. In the present invention, processing conditions for the neutralization step are not particularly limited, and general-purpose conditions can be used. For example, an aqueous solution of 3% by mass or more and 40% by mass or less of alkali is added, in an amount of usually 0.1% by mass or more and 5% by mass or less, preferably 0.5% by mass or more and 3% by mass or less, to the degummed oil. A neutralization temperature may be usually 20° C. or more and 120° C. or less, preferably 35° C. or more and 95° C. or less. The soap content insoluble in oils/fats is separated and removed by a centrifuge or the like to obtain a neutralized oil.

In Present Invention 1, the neutralization step (2) is preferably not performed.

The neutralization step may be performed by a physical refining method using no alkali. Examples of the physical refining method include a steam distillation method and a molecular distillation method.

In the bleaching step (3), a pigment contained in the oil content is adsorbed to activated clay, activated carbon, or the like under reduced pressure, and removed. The bleaching step is usually performed in the absence of water, but may be performed in the presence of water. As conditions for the bleaching step in a usual refining process, a usage amount of the activated clay is 0.05% by mass or more and 5% by mass or less based on the oil or fat, a bleaching temperature is 60° C. or more and 120° C. or less, and a bleaching time is 5 minutes or more and 120 minutes or less. The activated clay or the like stuck with the pigment in the bleaching step is removed by filtration under reduced pressure, or the like to obtain a bleached oil.

In Present Invention 1, the usage amount of the activated clay is preferably 0.05% by mass or more and 2% by mass or less, more preferably 0.05% by mass or more and 1% by mass or less, even more preferably 0.05% by mass or more and 0.7% by mass or less, still even more preferably 0.05% by mass or more and 0.6% by mass or less based on the degummed oil or the neutralized oil. The bleaching temperature is preferably 70° C. or more and 120° C. or less, more preferably 75° C. or more and 110° C. or less. Furthermore, the bleaching time is preferably 5 minutes or more and 80 minutes or less, more preferably 5 minutes or more and 60 minutes or less. When a mild bleaching step or no bleaching step is performed under such a condition, a prepared oil having an absorbance difference within a range prescribed in the present invention can be easily obtained.

In the deodorizing step (4), an odorous component contained in the oil content is removed by steam distillation under reduced pressure. In the deodorizing step under a usual refining condition, a usage amount of water vapor is 0.1% by mass or more and 10% by mass or less based on the oil or fat, a deodorizing temperature is 210° C. or more and 300° C. or less, a reduced pressure degree is 150 Pa or more and 1,000 Pa or less, and a deodorizing time is 10 minutes or more and 240 minutes or less. Note that, in Present Invention 1, the usage amount of water vapor is preferably 0.3% by mass or more and 8% by mass or less, more preferably 0.3% by mass or more and 5% by mass or less based on the degummed oil, the neutralized oil, or the bleached oil. The deodorizing temperature is preferably 200° C. or more and 300° C. or less, more preferably 230° C. or more and 300° C. or less, even more preferably 240° C. or more and 280° C. or less. The reduced pressure degree is preferably 200 Pa or more and 800 Pa or less depending on the temperature. In addition, the deodorizing time is preferably 20 minutes or more and 240 minutes or less depending on the deodorizing temperature and the reduced pressure degree. Particularly, the deodorizing step is performed under an enhanced refining condition that the usage amount of water vapor is 0.3% by mass or more and 5% by mass or less based on the oil or fat, the deodorizing temperature is 240° C. or more and 280° C. or less, and the deodorizing time is 20 minutes or more and 240 minutes or less, so that odor of the frying fats and oils composition during heating can be suppressed.

In Present Invention 1, the deodorizing step (4) is preferably performed.

An absorbance difference determined by subtracting an absorbance at a wavelength of 750 nm from an absorbance at a wavelength of 660 nm of the prepared oil after the step (3) using isooctane as a control is at least 0.030, preferably at least 0.045, more preferably at least 0.065, even more preferably at least 0.1. When the absorbance difference is at least 0.030, a strong effect of suppressing increase in the anisidine value can be obtained, and an amount of the prepared oil added to the edible oil or fat can be reduced. The upper limit of the absorbance difference is usually at most 2.0, preferably at most 1.5, more preferably at most 1.0.

Note that, in a case that the neutralization step (2) is or is not performed and the bleaching step (3) is performed, the absorbance difference refers to a calculated value of the bleached oil. In a case that the neutralization step (2) is performed and the bleaching step (3) is not performed, the absorbance difference refers to a calculated value of the neutralized oil. In a case that the neutralization step (2) is not performed and the bleaching step (3) is not performed, the absorbance difference refers to a calculated value of the degummed oil.

A content of the prepared oil in the frying fats and oils composition may usually be 0.05% by mass or more and 20% by mass or less, preferably 0.05% by mass or more and 15% by mass or less, more preferably 0.1% by mass or more and 15% by mass or less, even more preferably 0.25% by mass or more and 12% by mass or less, still even more preferably 0.45% by mass or more and 12% by mass or less.

The prepared oil may be added such that a content of a prepared oil-derived phosphorus in the fats and oils composition is preferably 0.01 ppm by mass or more and 10 ppm by mass or less, more preferably 0.1 ppm by mass or more and 10 ppm by mass or less.

The frying fats and oils composition may contain a silicone oil. For the silicone oil, a type which is usually blended into a frying edible oil or fat can be used. A kinematic viscosity of the silicone oil at 25° C. is preferably 10 cSt or more and 1,200 cSt or less, more preferably 80 cSt or more and 1,200 cSt or less, even more preferably 400 cSt or more and 1,200 cSt or less, particularly preferably 900 cSt or more and 1,100 cSt or less. A content of the silicone oil in the frying fats and oils composition is preferably 0.5 ppm by mass or more and 10 ppm by mass or less, more preferably 1 ppm by mass or more and 5 ppm by mass or less, even more preferably 2 ppm by mass or more and 4 ppm by mass or less, particularly preferably 3 ppm by mass.

A general-purpose auxiliary which is added to an edible oil or fat can be added to the frying fats and oils composition unless the effects of the present invention are inhibited. Examples of the auxiliary include an antioxidant such as tocopherol; a flavor; an emulsifier; and the like.

The frying fats and oils composition can be used for frying e.g. at 140° C. or more and 200° C. or less depending on a foodstuff and a cooking method. Examples of the fried food include deep-fried chicken, croquette, tempura, fried vegetable and fish without coating, cutlet, fritter, friedcake or fried bread, fried noodle, and the like.

Also, the present invention relates to an inhibitor for suppressing increase in an anisidine value of a frying fats and oils composition, the inhibitor for suppressing increase in the anisidine value containing a prepared oil, wherein

the prepared oil is obtained through

(1) a degumming step,

(2) a neutralization step which is performed or not performed,

(3) a bleaching step which is performed or not performed, and

(4) a deodorizing step which is performed or not performed, in this order, in a process of refining a crude oil obtained from an oil feedstock, and

an absorbance difference determined by subtracting an absorbance at a wavelength of 750 nm from an absorbance at a wavelength of 660 nm of the prepared oil after the step (3) is at least 0.030 when isooctane is used as a control. Since the details of the prepared oil are same as those described in the method for suppressing increase in the anisidine value, an explanation thereof is omitted.

A carrier (diluent) for the prepared oil in the inhibitor for suppressing increase in the anisidine value is usually an edible oil or fat, and specific examples of the edible oil or fat are the same as described as examples for the base oil of the frying fats and oils composition. Examples of an auxiliary which is appropriately added to the inhibitor for suppressing increase in the anisidine value include an antioxidant, an antifoaming agent, an emulsifier, a flavor, a physiologically active substance, and the like.

A content of the prepared oil in the inhibitor for suppressing increase in the anisidine value is usually 5% by mass or more and 100% by mass or less, preferably 10% by mass or more and 100% by mass or less, more preferably 20% by mass or more and 100% by mass or less.

The suppression of increase in the anisidine value according to the present invention can be evaluated in accordance with the following method, for example. Hereinafter, the anisidine value is simply referred to as AnV in some cases.

### 1. Measurement of Anisidine Value (AnV)

The AnV is defined as a value of 100 times the extinction coefficient E^{1%}_{1 cm} at 350 nm when activating a carbonyl compound with p-anisidine in a sample. An AnV of a test oil after a frying test is measured using an ultraviolet-visible spectrophotometer in accordance with Standard Methods for the Analysis of Fats, Oils and Related Materials 2. 5. 3-2013.

### 2. Calculation of AnV Increase Suppression Ratio

An AnV increase suppression ratio based on a measurement result of a control oil is calculated in accordance with the following equation.

$$AnV increase suppression rate ( \% ) = \{ 1 - \frac{AnV of test oil after frying test}{AnV of control oil after frying test} \} \times 100 \qquad [ Equation 1 ]$$

According to the present invention, the AnV increase suppression ratio based on the control oil without containing the prepared oil according to the present invention varies depending on an addition amount of the prepared oil, a foodstuff, a frying temperature, and the like, but is usually on the order of 0.2% to 20%.

The method for suppressing decrease in the amount of tocopherols in the frying fats and oils composition during heating according to the present invention (hereinafter referred to as Present Invention 2) includes a step of adding the prepared oil to an edible oil or fat. The edible oil or fat is the same as described in the embodiment of Present Invention 1.

A content of the edible oil or fat is usually 80% by mass or more, preferably 85% by mass or more, particularly preferably 90% by mass or more based on the frying fats and oils composition. An upper limit of the content of the edible oil or fat is not particularly limited, but a total content of the edible oil or fat and the prepared oil is 100% by mass or less.

The prepared oil is obtained through the degumming step (1), the neutralization step (2) which is performed or not performed, the bleaching step (3) which is performed or not performed, and the deodorizing step (4) which is performed or not performed, in this order, in the process of refining the crude oil obtained from the oil feedstock. The oil feedstock and the crude oil are the same as described in the embodiment of Present Invention 1.

In addition, the degumming step (1), the neutralization step (2), the bleaching step (3), and the deodorizing step (4) in Present Invention 2 can be performed under the same refining condition as in the aforementioned embodiment of Present Invention 1. In Present Invention 2, preferably the neutralization step (2) is not performed, and preferably the deodorizing step (4) is performed.

An absorbance difference determined by subtracting an absorbance at a wavelength of 750 nm from an absorbance at a wavelength of 660 nm of the prepared oil of Present Invention 2 after the step (3) using isooctane as a control is at least 0.030, preferably at least 0.045, more preferably at least 0.065, even more preferably at least 0.1. When the absorbance difference is at least 0.030, a high suppressing effect of decrease in the amount of tocopherols can be obtained, and an amount of the prepared oil added to the edible oil or fat can be reduced. The upper limit of the absorbance difference is usually at most 2.0, preferably at most 1.5, more preferably at most 1.0.

Note that, in a case that the neutralization step (2) is or is not performed and the bleaching step (3) is performed, the absorbance difference refers to a calculated value of the bleached oil. In a case that the neutralization step (2) is performed and the bleaching step (3) is not performed, the absorbance difference refers to a calculated value of the neutralized oil. In a case that the neutralization step (2) is not performed and the bleaching step (3) is not performed, the absorbance difference refers to a calculated value of the degummed oil.

A content of the prepared oil in the frying fats and oils composition may usually be 0.05% by mass or more and 20% by mass or less, preferably 0.05% by mass or more and 15% by mass or less, more preferably 0.1% by mass or more and 15% by mass or less, even more preferably 0.25% by mass or more and 12% by mass or less, still even more preferably 0.45% by mass or more and 12% by mass or less.

The prepared oil may be added such that a content of a prepared oil-derived phosphorus in the fats and oils composition is preferably 0.01 ppm by mass or more and 10 ppm by mass or less, more preferably 0.1 ppm by mass or more and 10 ppm by mass or less.

Preferably, the frying fats and oils composition contains a silicone oil. For the silicone oil, a type which is usually blended into a frying edible oil or fat can be used. A kinematic viscosity of the silicone oil at 25° C. is preferably 10 cSt or more and 1,200 cSt or less, more preferably 80 cSt or more and 1,200 cSt or less, even more preferably 400 cSt or more and 1,200 cSt or less, particularly preferably 900 cSt or more and 1,100 cSt or less. A content of the silicone oil in the frying fats and oils composition is preferably 0.5 ppm by mass or more and 10 ppm by mass or less, more preferably 1 ppm by mass or more and 5 ppm by mass or less, even more preferably 2 ppm by mass or more and 4 ppm by mass or less, particularly preferably 3 ppm by mass.

A general-purpose auxiliary which is added to an edible oil or fat can be added to the frying fats and oils composition unless the effects of the present invention are inhibited. Examples of the auxiliary include an antioxidant such as tocopherol; a flavor; an emulsifier; and the like.

The frying fats and oils composition can be used for frying e.g. at 140° C. or more and 200° C. or less depending on a foodstuff and a cooking method. Examples of the fried food include Deep-fried chicken, croquette, tempura, fried vegetable and fish without coating, cutlet, fritter, friedcake or fried bread, fried noodle, and the like.

Also, the present invention relates to an inhibitor for suppressing decrease in an amount of tocopherols in a frying fats and oils composition, the inhibitor for suppressing decrease in the amount of tocopherols containing a prepared oil, wherein

the prepared oil is obtained through

(1) a degumming step,

(2) a neutralization step which is performed or not performed,

(3) a bleaching step which is performed or not performed, and

(4) a deodorizing step which is performed or not performed, in this order, in a process of refining a crude oil obtained from an oil feedstock, and

an absorbance difference determined by subtracting an absorbance at a wavelength of 750 nm from an absorbance at a wavelength of 660 nm of the prepared oil after the step (3) is at least 0.030 when isooctane is used as a control. Since the details of the prepared oil are same as those described in the method for suppressing decrease in the amount of tocopherols, an explanation thereof is omitted.

The carrier (diluent) for the prepared oil in the tocopherol decrease inhibitor is usually an edible oil or fat, and specific examples of the edible oil or fat are the same as described for the base oil of the frying fats and oils composition as examples. Examples of auxiliaries to be appropriately added to the tocopherol decrease inhibitor include an antioxidant, an antifoaming agent, an emulsifier, a flavor, and a physiologically active substance.

A content of the prepared oil in the tocopherol decrease inhibitor is usually 5% by mass or more and 100% by mass or less, preferably 10% by mass or more and 100% by mass or less, more preferably 20% by mass or more and 100% by mass or less.

The suppression of decrease in the amount of tocopherols according to the present invention can be evaluated in accordance with the following method, for example. Hereinafter, the tocopherols are simply referred to as Toc in some cases.

### 1. Measurement of Tocopherols (Toc)

A test oil blended with an internal standard substance (2,2,5,7,8-pentamethyl-6-hydroxychroman, e.g. manufactured by Wako Pure Chemical Industries, Ltd.) is dissolved in hexane to prepare an analysis sample. Tocopherols in the analysis sample are analyzed by HPLC. A mass ratio of the internal standard substance and each tocopherol is applied to a calibration curve previously prepared by using a vitamin E quantifying standard reagent (e.g. manufactured by Wako Pure Chemical Industries, Ltd.) to quantify the tocopherols in the test oil.

### 2. Calculation of Toc Decrease Suppression Ratio

A Toc decrease suppression ratio of a test oil based on decrease in an amount of Toc in the control oil is calculated in accordance with the following equation.

$$Toc decrease suppression ratio ( \% ) = \{ 1 - \frac{\begin{matrix} \begin{matrix}Toc concentration in \\ test oil before frying test -\end{matrix} \\ \begin{matrix}Toc concentration in \\ test oil after frying test\end{matrix}\end{matrix}}{\begin{matrix} \begin{matrix}Toc concentration in \\ control oil before frying test -\end{matrix} \\ \begin{matrix}Toc concentration in \\ control oil after frying test\end{matrix}\end{matrix}} \} \times 100 \qquad [ Equation 2 ]$$

According to the present invention, the Toc decrease suppression ratio based on the control oil without containing the prepared oil according to the present invention is usually on the order of 0.5 to 40% depending on an addition amount of the prepared oil, foodstuffs, a frying temperature, and the like.

### EXAMPLES

Hereinafter, the present invention will be explained in more detail with reference to Examples of the present invention. However, the present invention is not limited to the following Examples. Note that, for a phosphorus content (ppm by mass) in each table, a value lower than a detection limit was represented by “0”. In addition, a phosphorus content (ppm by mass) in the fats and oils composition in each table refers to a value calculated from the phosphorus content in the prepared oil and the addition amount of the prepared oil.

### Preparation Example

### Preparation of Refined Oil and Prepared Oil

Each refined oil shown in Table 1 was prepared, and then each prepared oil was prepared in accordance with a characteristic of each refining process shown in Table 1.

TABLE 1

| | | | Phosphorus |
|---|---|---|---|
| | | Absorbance | Content |
| Name | Product Name Or Characteristic Of Refining Process Of Prepared Oil | Difference | (mass ppm) |
| Refined | Product Name “J Canola oil” (containing 3 mass ppm of silicone oil | 0.003 | 0 |
| Rapeseed | having kinematic viscosity of 1000 cSt, rapeseed oil, manufactured by J- | | |
| Oil | OIL MILLS, Inc.) | | |
| Prepared | In the usual refining process of rapeseed oil, the bleaching step is made | 0.100 | 0 |
| Oil 1 | milder (using acid clay (Product Name: SA90 (manufactured by Nippon | | |
| | Activated Clay Co., Ltd.)), 0.45 mass %, 80° C., 30 minutes). | | |
| Prepared | In usual refining process of rapeseed oil, the bleaching step is made | 0.173 | 0.6 |
| Oil 2 | milder (using acid clay (Product Name: SA90 (manufactured by Nippon | | |
| | Activated Clay Co., Ltd.)), 0.29 mass %, 80° C., 30 minutes). | | |
| Prepared | In the usual refining process of rapeseed oil, the bleaching step is made | 0.236 | 2.0 |
| Oil 3 | milder (using acid clay (Product Name: SA90 (manufactured by Nippon | | |
| | Activated Clay Co., Ltd.)), 0.3 mass %, 80° C., 30 minutes), and no | | |
| | deodorizing step is performed. | | |
| Prepared | In the usual refining process of rapeseed oil, no bleaching step and no | 0.359 | 2.8 |
| Oil 4 | deodorizing step are performed. | | |
| Prepared | In the usual refining process of rapeseed oil, no bleaching step is | 0.389 | 1.8 |
| Oil 5 | performed. | | |
| Prepared | In the usual refining process of rapeseed oil, no bleaching step is | 0.359 | 2.8 |
| Oil 6 | performed. | | |
| Prepared | In the usual refining process of rapeseed oil, no bleaching step is | 0.378 | 1.8 |
| Oil 7 | performed. | | |
| Prepared | In the usual refining process of rapeseed oil, no bleaching step is | 0.437 | 12.8 |
| Oil 8 | performed, and the deodorizing step is changed (250° C., usage amount of | | |
| | water vapor: 2 mass %, 45 minutes, degree of vacuum: 400-700 Pa). | | |
| Prepared | In the usual refining process of rapeseed oil, no bleaching step is | 0.437 | 12.4 |
| Oil 9 | performed, and the deodorizing step is changed (270° C., usage amount of | | |
| | water vapor: 2 mass %, 45 minutes, degree of vacuum: 400-700 Pa). | | |
| Prepared | In the usual refining process of rapeseed oil, no bleaching step is | 0.437 | 12.2 |
| Oil 10 | performed, and the deodorizing step is changed (250° C., usage amount of | | |
| | water vapor: 8 mass %, 180 minutes, degree of vacuum: 400-700 Pa). | | |
| Prepared | In the usual refining process of rapeseed oil, no neutralization step is | 0.346 | 185.9 |
| Oil 11 | performed, and the bleaching step is changed to mild bleaching step is | | |
| | made milder (using acid clay (Product Name: SA90 (manufactured by | | |
| | Nippon Activated Clay Co., Ltd.)), 0.25 mass %, 80° C. ° C., 30 minutes). | | |
| Prepared | In the usual refining process of rapeseed oil, no neutralization step and no | 0.443 | 126.7 |
| Oil 12 | bleaching step are performed | | |
| Prepared | In the usual refining process of rapeseed oil, no neutralization step and no | 0.587 | 130.1 |
| Oil 13 | bleaching step are performed | | |
| Refined | Product Name “J Soybean Shirashime (refined) Oil” (containing 3 mass | 0.003 | 0 |
| Soybean | ppm of silicone oil having kinematic viscosity of 1000 cSt, soybean oil, | | |
| Oil | manufactured by J-OIL MILLS, Inc.) | | |
| Prepared | In the usual refining process of soybean oil, no bleaching step is | 0.035 | 1.6 |
| Oil 14 | performed | | |
| Prepared | Soybean oil subjected to the usual refining process | 0.003 | 0 |
| Oil 15 | | | |
| Refined | Product Name “Frying Oil J” (containing 3 mass ppm of silicone oil | 0.003 | 0 |
| Palm | having kinematic viscosity of 1000 cSt, palm olein, iodine value: 67, | | |
| Olein | manufactured by J-OIL MILLS, Inc.) | | |

Absorbance differences of each refined oil and prepared oil were calculated, and phosphorus contents in the refined oil and prepared oil were measured in accordance with the following method.

### (Absorbance Difference)

Isooctane (spectrometry reagent, manufactured by Wako Pure Chemical Industries, Ltd.) was put into quartz cells (1 cm) for control and measurement, and baseline correction was performed in a range of 600 to 750 nm using an ultraviolet visible spectrophotometer (product name: “SHIMADZU UV-2450” manufactured by Shimadzu Corporation). Subsequently, the test oil or fat was put into the quartz cell for measurement, and measured an absorbance. An absorbance (absorbance difference) at 660 nm relative to an absorbance of zero at 750 nm was described.

(Phosphorus Content)

The test oil or fat was diluted with xylene, and analyzed using ICP emission spectrophotometer (manufactured by Hitachi High-Tech Science Corporation). Additionally, for quantification, CONOSTAN (registered trademark) Oil Analysis Standard (manufactured by SCP SCIENCE) was used.

### Examples 1 to 3

### Test of Changing Bleaching Step of Prepared Oil

### (1) Preparation of Frying Fats and Oils Composition

Each prepared oil shown in Table 2 was added to the refined rapeseed oil as a base oil in an amount of 2% by mass to prepare each frying fats and oils composition. Hereinafter, the base oil is referred to as a control oil, and the fats and oils composition obtained by adding the prepared oil to the base oil is referred to as test oil.

(2) Frying Test

The frying test of the test oil and the control oil was performed in the following procedure. Note that the frying test of the control oil was also performed for each test. The same applies to the other examples.

First, as a fried food for the frying test, the following processed foods were prepared.

Deep-fried chicken: product name “Wakadori Karaage (GX388)” (manufactured by AJINOMOTO FROZEN FOOD Co., Inc.)

Potato croquette: product name “NEW Potato croquette 60 (GC080)” (about 60 g/piece, manufactured by AJINOMOTO FROZEN FOOD Co., Inc.)

Into an electric fryer (product name: FM-3HR, manufactured by MACH Electric Cooker), 3.4 kg of test oil or control oil was put, and heated to a frying temperature of 180° C. After heating, the Deep-fried chicken or the potato croquette was put into the electric fryer with the following requirements, frying was performed for 10 hours a day, i.e. for a cumulative total time of 30 hours.

(Frying Condition)

[Deep-fried chicken] mass of chicken: 400 g/frying, frying time: 5 minutes/frying, number of frying: 5 times/day (performed on the first day to third day)

[Potato croquette] number of croquettes: 5 pieces/frying, frying time: 5 minutes/frying, number of frying: 2 times/day (performed only on the first day)

(3) Evaluation of Suppression of Increase in Anisidine Value and Decrease in Amount of Tocopherols in Fats and Oils Composition

The test oil and the control oil after the frying test were sampled, and evaluated for the suppressing effect of suppression of increase in the anisidine value and decrease in the amount of tocopherols in accordance with the following method.

### (Evaluation of Suppression of Increase in Anisidine Value of Fats and Oils Composition During Frying)

### 1. Measurement of Anisidine Value (AnV)

AnVs of the test oil and the control oil after the frying test were determined in accordance with Standard Methods for the Analysis of Fats, Oils and Related Materials 2. 5. 3-2013.

### 2. Calculation of AnV Increase Suppression Ratio

An AnV increase suppression ratio based on a measurement result of a control oil was calculated in accordance with the following equation.

$$AnV increase suppression rate ( \% ) = \{ 1 - \frac{AnV of test oil after frying test}{AnV of control oil after frying test} \} \times 100 \qquad [ Equation 3 ]$$

The results are shown in Table 2.

### (Evaluation of Suppression of Decrease in Amount of Tocopherol in Fats and Oils Composition During Frying)

### 1. Measurement of Tocopherol

About 0.2 g of test oil or control oil was precisely weighed out into a 10 mL measuring flask, to which 1 mL of internal standard substance (2,2,5,7,8-pentamethyl-6-hydroxychroman, e.g. manufactured by Wako Pure Chemical Industries, Ltd., 10.2 μg/mL hexane) was added, which was diluted with hexane in the measuring flask to prepare an analysis sample. Toc in the analysis sample was analyzed by HPLC. Conditions for HPLC are described below.
Column: InertSil (registered trademark) NH2 (2.1 mm×250 mm, 5 μm)
Column temperature: 60° C.
Detector: SHIMADZU fluorescence detector RF-10AXL
Detention wavelength: Ex 295 nm, Em 325 nm
Mobile phase: 98% by volume of hexane: 2% by volume of 2-propanol
(99% by volume of hexane: 1% by volume of 2-propanol, in a case of analyzing tocotrienol)
Injection volume: 2 μL
Flow rate: 0.5 mL/min

A mass ratio of the internal standard substance and each tocopherol was applied to a calibration curve prepared by using a vitamin E quantifying standard reagent (manufactured by Wako Pure Chemical Industries, Ltd.) to quantify Toc contained in the test oil or the control oil. Since a standard reagent for tocotrienol is difficult to obtain, each quantitative value of α, β, γ and δ-tocotrienol was calculated using α, β, γ or δ-tocopherol in the vitamin E quantifying standard reagent, respectively.

### 2. Calculation of Toc Decrease Suppression Ratio

A Toc decrease suppression ratio of a test oil based on Toc decrease in a control oil was calculated in accordance with the following equation.

$$Toc decrease suppression ratio ( \% ) = \{ 1 - \frac{\begin{matrix} \begin{matrix}Toc concentration in \\ test oil before frying test -\end{matrix} \\ \begin{matrix}Toc concentration in \\ test oil after frying test\end{matrix}\end{matrix}}{\begin{matrix}\begin{matrix}Toc concentration in \\ control oil before frying test -\end{matrix} \\ \begin{matrix}Toc concentration in \\ control oil after frying test\end{matrix}\end{matrix}} \} \times 100 \qquad [ Equation 4 ]$$

The results are shown in Table 2.

TABLE 2

| | Raw material composition of Fats and oils composition | | | | | | | | | Fats and oils | | | |
|---|---|---|---|---|---|---|---|---|---|---|---|---|---|
| | | Prepared Oil | | | | | | | | composition | | | |
| | | | | | | | | | Addi- | Analysis Value | | AnV | Toc |
| | | | | | | | | Phospho- | tion | Phospho- | | Increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Compar- | Refined | — | | | | | | | | — | 704.2 | — | — |
| ative | Rapeseed | | | | | | | | | | | | |
| Example 1 | Oil | | | | | | | | | | | | |
| Example 1 | | Prepared | ◯ | ◯ | Δ | ◯ | 0.100 | 0 | 2.0 | 0 | 702.5 | 1.8 | 1.9 |
| | | Oil 1 | | | | | | | | | | | |
| Example 2 | | Prepared | ◯ | ◯ | Δ | ◯ | 0.173 | 0.6 | 2.0 | 0.012 | 697.4 | 5.7 | 9.1 |
| | | Oil 2 | | | | | | | | | | | |
| Example 3 | | Prepared | ◯ | ◯ | X | ◯ | 0.389 | 1.8 | 2.0 | 0.036 | 698.7 | 5.5 | 13.2 |
| | | Oil 5 | | | | | | | | | | | |

◯: Usual Refining Condition, Δ: Mild Refining Condition, X: Not Performed

As described in Examples 1 to 3, in the test oil blended with the prepared oil having an absorbance difference according to the present invention, the AnV increase was suppressed by 1.8 to 5.7% compared to the control oil (refined rapeseed oil subjected to degumming step, neutralization step, bleaching step, and deodorizing step under a usual condition). It was found that the prepared oil prepared so as to have a certain absorbance difference after the bleaching step according to the present invention had a function of suppressing the AnV increase in the fats and oils composition during frying.

In Examples 1 to 3 using the fats and oils composition blended with the prepared oil according to the present invention, the Toc decrease was suppressed compared to the control oil. Thus, it was found that the prepared oil having a certain absorbance difference after the bleaching step according to the present invention had a function of suppressing the Toc decrease in the fats and oils composition during frying.

### Examples 4 to 6

### Test of Changing Deodorizing Step of Prepared Oil (1)

For the purpose of testing whether or not the prepared oil used in the present invention needed to be subjected to the deodorizing step in the refining process, a prepared oil 3 subjected to the mild bleaching step but not to the deodorizing step, a prepared oil 4 not subjected to the bleaching and deodorizing steps, or a prepared oil 6 not subjected to the bleaching step but to the deodorizing step was added to a base oil in an amount of 1.6 or 2.0% by mass to prepare each test oil. A frying test and evaluation of the test oils were performed in the same operation as in Example 1. The results are shown in Table 3.

TABLE 3

| | Raw material composition of Fats and oils composition | | | | | | | | | Fats and oils | | | |
|---|---|---|---|---|---|---|---|---|---|---|---|---|---|
| | | Prepared Oil | | | | | | | | composition | | | |
| | | | | | | | | | Addi- | Analysis Value | | AnV | Toc |
| | | | | | | | | Phospho- | tion | Phospho- | | increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Comparative | Refined | — | | | | | | | | — | 633.6 | 0.0 | — |
| Example 2 | Rapeseed | | | | | | | | | | | | |
| Example 4 | Oil | Prepared | ◯ | ◯ | Δ | X | 0.236 | 2.0 | 2.0 | 0.040 | 634.5 | 3.5 | 7.5 |
| | | Oil 3 | | | | | | | | | | | |
| Comparative | Refined | — | | | | | | | | — | 716.3 | — | — |
| Example 3 | Rapeseed | | | | | | | | | | | | |
| Example 5 | Oil | Prepared | ◯ | ◯ | X | X | 0.359 | 2.8 | 1.6 | 0.045 | 697.0 | 3.1 | 11.1 |
| | | Oil 4 | | | | | | | | | | | |
| Example 6 | | Prepared | ◯ | ◯ | X | ◯ | 0.359 | 2.8 | 1.6 | 0.045 | 697.6 | 11.8 | 33.7 |
| | | Oil 6 | | | | | | | | | | | |

◯: Usual Refining Condition, Δ: Mild Refining Condition, X: Not Performed

As described in Examples 4 and 5, in the test oil containing the prepared oil having an absorbance difference prescribed in the present invention, the AnV increase and the Toc decrease during frying were improved compared to the control oil even without being subjected to the deodorizing step. Furthermore, when comparing Example 5 with Example 6, the test oil in Example 6 containing the prepared oil subjected to the deodorizing step shows higher AnV increase and Toc decrease suppression ratios. Thus, it may be more preferable that the prepared oil used in the present invention is subjected to the deodorizing step.

### Examples 7 to 9

### Test of Changing Deodorizing Step of Prepared Oil (2)

For the purpose of studying the refining conditions in the deodorizing step of the prepared oil used in the present invention, each of a prepared oil 8 subjected to a usual deodorizing step, or prepared oils 9 and 10 subjected to an enhanced deodorizing step was added to a base oil in an amount of 2.0% by mass to prepare each test oil. A frying test and evaluation of these test oils were performed in the same procedure as in Example 1. The results are shown in Table 4.

TABLE 4

| | Raw material composition of Fats and oils composition | | | | | | | | | Fats and oils | | | |
|---|---|---|---|---|---|---|---|---|---|---|---|---|---|
| | | Prepared Oil | | | | | | | | composition | | | |
| | | | | | | | | | Addi- | Analysis Value | | AnV | Toc |
| | | | | | | | | Phospho- | tion | Phospho- | | increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Comparative | Refined | — | | | | | | | | — | 668.2 | — | — |
| Example 4 | Rapeseed | | | | | | | | | | | | |
| Example 7 | Oil | Prepared | ◯ | ◯ | X | ◯ | 0.437 | 12.8 | 2.0 | 0.26 | 668.4 | 6.4 | 12.3 |
| | | Oil 8 | | | | | | | | | | | |
| Example 8 | | Prepared | ◯ | ◯ | X | ⊚ | 0.437 | 12.4 | 2.0 | 0.25 | 671.9 | 13.1 | 22.7 |
| | | Oil 9 | | | | | | | | | | | |
| Example 9 | | Prepared | ◯ | ◯ | X | ⊚ | 0.437 | 12.2 | 2.0 | 0.24 | 657.0 | 9.2 | 26.0 |
| | | Oil 10 | | | | | | | | | | | |

◯: Usual Refining Condition, X: Not Performed, ⊚: Enhanced Refining Condition

As shown in Table 4, in all deodorizing conditions, the AnV increase and the Toc decrease in the test oil during frying were suppressed compared to the control oil. When comparing Example 7 with Examples 8 and 9, Example 8 and 9 under the strengthened deodorizing condition showed higher AnV increase and Toc decrease suppression ratios in the test oil.

### Examples 10 to 12

### Test of Changing Neutralization Step of Prepared Oil

For the purpose of testing whether or not the prepared oil used in the present invention needed to be subjected to the neutralization step in the refining process, prepared oils 11 to 13 having absorbance differences but not subjected to the bleaching and deodorizing steps were added to a base oil in an amount of 2.0% by mass to prepare each test oil. A frying test and evaluation of these test oils were performed in the same operation as in Example 1. The results are shown in Table 5.

TABLE 5

| | Raw material composition of Fats and oils composition | | | | | | | | | Fats and oils | | | |
|---|---|---|---|---|---|---|---|---|---|---|---|---|---|
| | | Prepared Oil | | | | | | | | composition | | | |
| | | | | | | | | | Addi- | Analysis Value | | AnV | Toc |
| | | | | | | | | Phospho- | tion | Phospho- | | increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Comparative | Refined | — | | | | | | | | — | 645.4 | — | — |
| Example 5 | Rapeseed | | | | | | | | | | | | |
| Example 10 | Oil | Prepared | ◯ | X | Δ | ◯ | 0.346 | 185.9 | 2.0 | 3.7 | 635.7 | 0.7 | 6.3 |
| | | Oil 11 | | | | | | | | | | | |
| Comparative | Refined | — | | | | | | | | — | 643.4 | — | — |
| Example 6 | Rapeseed | | | | | | | | | | | | |
| Example 11 | Oil | Prepared | ◯ | X | X | ◯ | 0.443 | 126.7 | 2.0 | 2.5 | 634.1 | 2.6 | 14.4 |
| | | Oil 12 | | | | | | | | | | | |
| Comparative | Refined | — | | | | | | | | — | 695.8 | — | — |
| Example 7 | Rapeseed | | | | | | | | | | | | |
| Example 12 | Oil | Prepared | ◯ | X | X | ◯ | 0.587 | 130.1 | 2.0 | 2.6 | 686.3 | 6.1 | 20.2 |
| | | Oil 13 | | | | | | | | | | | |

◯: Usual Refining Condition, Δ: Mild Refining Condition, X: Not Performed

As shown in Table 5, the prepared oil used in the present invention was proved to obtain AnV increase and Toc decrease-suppressing effects even without the neutralization step. When comparing Example 7 with Example 11, it can be seen that the prepared oil subjected to the neutralization step is preferable for the AnV increase suppression ratio, and the prepared oil not subjected to the neutralization step is preferable for the Toc decrease suppression ratio.

### Examples 13 to 16

### Test of Changing Addition Amount of Prepared Oil

A test of changing an addition amount of the prepared oil in the frying fats and oils composition according to the present invention was performed. Specifically, in an addition amount shown in Table 6, a prepared oil 7 not subjected to the bleaching step in the refining process of the rapeseed crude oil was added to a base oil to prepare each test oil. A frying test and evaluation of these test oils were performed in the same operation as in Example 1. The results are shown in Table 6.

TABLE 6

| | Raw material composition of Fats and oils composition | | | | | | | | | | | | |
|---|---|---|---|---|---|---|---|---|---|---|---|---|---|
| | | Prepared Oil | | | | | | | | Fats and oils | | | |
| | | | | | | | | | Addi- | composition | | AnV | Toc |
| | | | | | | | | Phospho- | tion | Phospho- | | increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Comparative | Refined | — | | | | | | | | — | 712.2 | — | — |
| Example 8 | Rapeseed | | | | | | | | | | | | |
| Example 13 | Oil | Prepared | ◯ | ◯ | X | ◯ | 0.378 | 1.80 | 0.3 | 0.005 | 703.6 | 0.2 | 4.2 |
| Example 14 | | Oil 7 | | | | | | | 0.7 | 0.013 | 706.1 | 4.9 | 16.1 |
| Example 15 | | | | | | | | | 6.0 | 0.108 | 691.6 | 7.2 | 21.6 |
| Example 16 | | | | | | | | | 10.1 | 0.182 | 684.3 | 7.1 | 26.1 |

◯: Usual Refining Condition, X: Not Performed

When frying was performed using the test oil blended with the prepared oil according to the present invention as shown in Table 6, the AnV increase and Toc decrease in the fats and oils composition after the frying test was suppressed compared to the control oil. From the results in Examples 13 to 16, when a content of the prepared oil in the frying fats and oils composition was 0.3% by mass or more and 10.1% by mass or less, an effect could be obtained, when the content was 0.7% by mass or more and 10.1% by mass or less, a higher effect could be obtained, and when the content was 6.0% by mass or more and 10.1% by mass or less, an even more higher effect could be obtained.

### Example 17

### Test of Changing Base Oil

In Example 3, a test of changing the base oil was performed. As the base oil, a refined palm olein was prepared. This refined palm olein contains more tocotrienol than Tocopherol as Toc. In Example 3, a test oil was prepared by adding of the prepared oil to the base oil in an amount of 2.0% by mass in the same procedure as in Example 3 except that the base oil was changed from the refined rapeseed oil to the refined palm olein. A frying test and evaluation of this test oil were performed by the same operation as in Example 1. The results are shown in Table 7.

TABLE 7

| | Raw material composition of Fats and oils composition | | | | | | | | | Fats and oils | | | |
|---|---|---|---|---|---|---|---|---|---|---|---|---|---|
| | | Prepared Oil | | | | | | | | composition | | | |
| | | | | | | | | | Addi- | Analysis Value | | AnV | Toc |
| | | | | | | | | Phospho- | tion | Phospho- | | increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Comparative | Refined | — | | | | | | | | — | 733.0 | — | — |
| Example 9 | Palm | | | | | | | | | | | | |
| Example 17 | Olein | Prepared | ◯ | ◯ | X | ◯ | 0.378 | 1.8 | 2.0 | 0.036 | 746.5 | 9.7 | 4.5 |
| | | Oil 7 | | | | | | | | | | | |

◯: Usual Refining Condition, X: Not Performed

As shown in Table 7, the AnV increase and Toc decrease in the oil or fat during frying could be suppressed even when the base oil was changed from the refined rapeseed oil to the refined palm olein. When comparing Example 3 with Example 17, the base oil is preferably palm oil in terms of suppressing the AnV increase, and the base oil is preferably rapeseed oil in terms of suppressing the Toc decrease.

### Example 18

### Test of Changing Oil Feedstock of Prepared Oil

A test in which an oil feedstock of the prepared oil was changed from rapeseed to soybean was performed. A prepared oil 14 derived from soybean and not subjected to the bleaching step was added to a base oil in an amount of 10% by mass to prepare a test oil. In addition, a soybean oil (prepared oil 15) subjected to a usual refining process was added to a refined rapeseed oil in an amount of 10% by mass to prepare a control oil of Comparative Example 10. A frying test of the test oil and the control oil was performed in the same operation as in Example 1. The results are shown in Table 8.

TABLE 8

| | Raw material composition of Fats and oils composition | | | | | | | | | Fats and oils | | | |
|---|---|---|---|---|---|---|---|---|---|---|---|---|---|
| | | Prepared Oil | | | | | | | | composition | | | |
| | | | | | | | | | Addi- | Analysis Value | | AnV | Toc |
| | | | | | | | | Phospho- | tion | Phospho- | | increase | Decrease |
| | | | | | | | Absor- | rous | A- | rous | | Suppres- | Suppres- |
| | | | Refining Process | | | | bance | Content | mount | Content | Toc | sion | sion |
| | Base | | Degum- | Neutral- | Bleach- | Deodor- | Differ- | (mass | (mass | (mass | (mass | Ratio | Ratio |
| | Oil | | ming | ization | ing | izing | ence | ppm) | %) | ppm) | ppm) | (%) | (%) |
| Comparative | Refined | — | | | | | | | | — | 663.5 | 0.0 | — |
| Example 10 | Rapeseed | | | | | | | | | | | | |
| Example 18 | Oil: | Prepared | ◯ | ◯ | X | ◯ | 0.035 | 1.6 | 10.0 | 0.160 | 664.7 | 5.1 | 11.5 |
| | Refined | Oil 14 | | | | | | | | | | | |
| | Soybean | | | | | | | | | | | | |
| | Oil = 9:1 | | | | | | | | | | | | |

◯: Usual Refining Condition, X: Not Performed

As shown in Table 8, the AnV increase and Toc decrease in the fats and oils composition after the frying test could be suppressed even when the oil feedstock of the prepared oil was changed from rapeseed to soybean. When comparing Example 16 with Example 18, it can be seen that the oil feedstock of the prepared oil is preferably rapeseed.

1. A method for suppressing increase in an anisidine value of a frying fats and oils composition, the method including adding a prepared oil to an edible oil or fat, wherein
the prepared oil is obtained through
(1) a degumming step,
(2) a neutralization step which is performed or not performed,
(3) a bleaching step which is performed or not performed, and
(4) a deodorizing step which is performed or not performed, in this order, in a process of refining a crude oil obtained from an oil feedstock, and
an absorbance difference determined by subtracting an absorbance at a wavelength of 750 nm from an absorbance at a wavelength of 660 nm of the prepared oil after the step (3) is at least 0.030 when isooctane is used as a control.

2. The method for suppressing increase in the anisidine value as claimed in claim 1, wherein the absorbance difference is at least 0.045.

3. The method for suppressing increase in the anisidine value as claimed in claim 1, wherein the deodorizing step (4) is performed.

4. The method for suppressing increase in the anisidine value as claimed in claim 1, wherein the deodorizing step is performed under a condition that:
a usage amount of water vapor is 0.1% by mass or more and 10% by mass or less,
a deodorizing temperature is 210° C. or more and 300° C. or less, and
a deodorizing time is 10 minutes or more and 240 minutes or less.

5. The method for suppressing increase in the anisidine value as claimed in claim 1, wherein the oil feedstock is at least one selected from soybean, rapeseed, and palm flesh.

6. The method for suppressing increase in the anisidine value as claimed in claim 1, wherein the edible oil or fat contains at least one selected from soybean oil, rapeseed oil, palm-based oil or fat, corn oil, sunflower oil, olive oil, cottonseed oil, rice bran oil, and safflower oil.

7. The method for suppressing increase in the anisidine value as claimed in claim 1, wherein a content of the prepared oil in the frying fats and oils composition is 0.05% by mass or more and 20% by mass or less.

8. The method for suppressing increase in the anisidine value as claimed in claim 1, wherein the prepared oil is added to the edible oil or fat such that a phosphorus content derived from the prepared oil in the frying fats and oils composition is 0.01 ppm by mass or more and 10 ppm by mass or less.

9. The method for suppressing increase in the anisidine value as claimed in claim 1, wherein the bleaching step (3) is performed.

10. A method for suppressing decrease in an amount of tocopherols in a frying fats and oils composition, the method including adding a prepared oil to an edible oil or fat, wherein
the prepared oil is obtained through
(1) a degumming step,
(2) a neutralization step which is performed or not performed,
(3) a bleaching step which is performed or not performed, and
(4) a deodorizing step which is performed or not performed, in this order, in a process of refining a crude oil obtained from an oil feedstock, and
an absorbance difference determined by subtracting an absorbance at a wavelength of 750 nm from an absorbance at a wavelength of 660 nm of the prepared oil after the step (3) is at least 0.030 when isooctane is used as a control.

11. The method for suppressing decrease in the amount of tocopherols as claimed in claim 10, wherein the absorbance difference is at least 0.45.

12. The method for suppressing decrease in the amount of tocopherols as claimed in claim 10, wherein the deodorizing step (4) is performed.

13. The method for suppressing decrease in the amount of tocopherols as claimed in claim 10, wherein the deodorizing step is performed under a condition of:
a concentration of water vapor of 0.3% by mass or more and 10% by mass or less,
210° C. or more and 300° C. or less, and
20 minutes or more and 240 minutes or less.

14. The method for suppressing decrease in the amount of tocopherols as claimed in claim 10, wherein the oil feedstock is at least one selected from soybean, rapeseed, and palm flesh.

15. The method for suppressing decrease in the amount of tocopherols as claimed in claim 10, wherein the edible oil or fat is at least one selected from soybean oil, rapeseed oil, palm-based oil or fat, corn oil, sunflower oil, olive oil, cottonseed oil, and safflower oil.

16. The method for suppressing decrease in the amount of tocopherols as claimed in claim 10, wherein a content of the prepared oil in the frying fats and oils composition is 0.05% by mass or more and 20% by mass or less.

17. The method for suppressing decrease in the amount of tocopherols as claimed in claim 10, wherein the prepared oil is added to the edible oil or fat such that a phosphorus content derived from the prepared oil in the frying fats and oils composition is 0.01 ppm by mass or more and 10 ppm by mass or less.

18. An inhibitor for suppressing increase in an anisidine value of a frying fats and oils composition, the inhibitor for suppressing increase in the anisidine value containing a prepared oil, wherein
the prepared oil is obtained through
(1) a degumming step,
(2) a neutralization step which is performed or not performed,
(3) a bleaching step which is performed or not performed, and
(4) a deodorizing step which is performed or not performed, in this order, in a process of refining a crude oil obtained from an oil feedstock, and
an absorbance difference determined by subtracting an absorbance at a wavelength of 750 nm from an absorbance at a wavelength of 660 nm of the prepared oil after the step (3) is at least 0.030 when isooctane is used as a control.

19. An inhibitor for suppressing decrease in an amount of tocopherols in a frying fats and oils composition, the inhibitor for suppressing decrease in the amount of tocopherols containing a prepared oil, wherein
the prepared oil is obtained through
(1) a degumming step,
(2) a neutralization step which is performed or not performed,
(3) a bleaching step which is performed or not performed, and
(4) a deodorizing step which is performed or not performed, in this order, in a process of refining a crude oil obtained from an oil feedstock, and
an absorbance difference determined by subtracting an absorbance at a wavelength of 750 nm from an absorbance at a wavelength of 660 nm of the prepared oil after the step (3) is at least 0.030 when isooctane is used as a control.
